(19) United States
(12) Patent Application Publication
(10) Pub. No.: US 2023/0373238 A1
(43) Pub. Date: Nov. 23, 2023

(54) TARGET RETAINING DEVICE

(71) Applicants: Eben Berry, Brunswick, ME (US); Julie Berry, Brunswick, ME (US); Michael Vickery, Saco, ME (US)

(72) Inventors: Eben Berry, Brunswick, ME (US); Julie Berry, Brunswick, ME (US); Michael Vickery, Saco, ME (US)

(21) Appl. No.: 17/746,861

(22) Filed: May 17, 2022

(51) Int. Cl. B43M 15/00

(52) U.S. Cl. CPC B43M 15/00; F41J 1/00

(57) ABSTRACT

The present invention relates to a target retainer device for adhering a target to a substrate for a variety of target and substrate types. The target retainer includes an impact-hold-resistant shaft to ensure the target remains in place during impact over multiple uses but can be easily inserted and removed from a substrate or a substrate covering or exterior to allow for reuse. The target retainer is available in multiple lengths for the best performance and ease of use based on substrates or substrate coverings or exteriors.

### BACKGROUND OF THE INVENTION

### 1. Field of the Invention

This present invention relates to a device for securing targets to substrates and substrate coverings or exteriors, for all methods of target identification, acquisition, and target shooting. More specifically, the present invention relates to securing and identifying targets to substrates and substrate coverings or exteriors across firearm, air-gun, and archery projectile delivery, and maintaining such targets substantially in position upon impact by the projectile.

### 2. Description of the Prior Art

Over the years, a variety of different target retainers have been developed to hold various targets in place to target substrates, for shooting practice across archery, firearms and air-guns. Some target retainer materials are made with plastics, metal, or a combination of both. Some target retainers serve only to work with one or two specific substrates or substrate coverings or exteriors, versus a variety of target substrates such as foam, cardboard, and hay, with various substrate coverings or exteriors, such as plastic, burlap, poly-wrapped, polyurethane and nylon fabric. A variety of target retainers have been developed to work with a particular dense or loose composition substrate and substrate covering or exterior.

The technology use and applications of current target retainers focuses more on recreational purposes and is limited in professional or commercial use. Target retainers utilize a wide variety of materials, such as but not limited to polycarbonate, nylon, polylactic acid and Acrylonitrile Butadiene Styrene and manufactured through 3D printing and injection mold manufacturing processes. Some target retainer designs have different uses for securing targets to target substrates or target exteriors. Current retainers are typically designed to be used with a specific target type, target substrate, or target exterior but lack the utility to be used with different types of targets, target substrates, or substrate coverings or exteriors because of the design, size, or other features.

Target substrates may vary in density and composition, requiring the use of target retainers specifically designed for that substrate, leading to limited utility across multiple substrates. For example, some target retainers may work well securing a target to a dense composition substrate, but not a loose composition substrate while other retainers may work well with securing a target to a loose composition substrate but not a dense composition substrate. Some retainers may also lack impact hold resistance and the durability necessary for repeated use.

Current target retainers typically have a specific use and therefore are of limited applicability across a range of projectile types. Archery targets are typically separate from that of targets used for shooting practice with firearms or air-guns. Archery targets may be comprised of a less dense, softer substrate while firearms or air-gun targets may be comprised of a denser substrate. Some target retainers are clips, which are used for hanging or suspending targets. Other target retainers are pins, which are stuck through a target to pin it to a surface. Additionally, some target retainers are staples requiring a staple gun or other additional equipment. These current target retainers lack the utility to be used for various targets and target substrates that have limited ability to maintain position upon impact, for example, when high velocity projectiles are delivered to the target, but not limited thereto.

Current technology fails to include a balanced ergonomic method for inserting and/or removing the target retainer which also provides an increased ability to hold a target in place during projectile impact with uses across firearm, air-gun, and archery projectile delivery. Many target retainers are difficult to insert into or remove from a substrate based on ergonomic design, shaft thickness, and repeated piercing sharpness durability. This may be due to a lack of grip features or the target retainer may fail to have a feature which allows a portion of the retainer to protrude such that the user may hold to apply sufficient pressure during the insertion of the retainer into a single substrate or across different substrate types. These target retainers may not have an ergonomic construct for ease of gripping. In addition, the tips of existing retainers may not be sharp enough for easy insertion and additional holding resistance during impact. Additionally, some retainers, such as pins may lack the durability to be reused or used with substrates of varying densities. Further, current technology fails to have features that protect the target retainer and the projectile from damage if the retainer is struck by the projectile. This may lead to further limited durability, impact hold resistance for continuous use, and re-usability and potential safety concerns.

What is needed is target retainer with an ergonomic handle construct for improving grip for inserting or removing the target retainer. What is also needed is an ergonomic handle construct that also provides additional hold resistance during impact, increased durably for re-usability, and deflection capabilities if the retainer is struck by a projectile. Additionally, what is further needed is a target retainer which may be used across various substrates, substrate coverings, or substrate exteriors such that the target retainer may be used with archery target substrates, firearm target substrates, and air-gun target substrates. The target retainer should be effective across various densities or composition of targets or substrates. Additionally, what is needed is a target retainer that may pierce the various substrates and retaining the target in a usable fashion. The target retainer should have durability features to protect the retainer from damage and increase re-usability. More specifically, what is needed is a durable and adaptable target retaining device which may be grasped easily such that the user may insert or remove the device from the substrate.

### SUMMARY OF THE INVENTION

The present invention is a target retainer for use with various substrates. The target retainer of the present invention may be removed from the substrate and reused. The retainer is configured to be used with substrates of various densities and composition. This may include use with archery targets, firearm targets, air-gun targets, or other such apparatuses. Prior to this invention, target retaining devices were limited in use to specific substrates and not conducive to insertion, impact hold resistance, removal, or re-use across multiple substrates and substrate densities.

The present invention is a target retainer which has a head, a shaft, and a tip. The head is designed such that the retainer is able to be easily grasped to insert or remove the retainer from the target substrate. The head may contain an optional finger hole or finger grip so that the user may insert their finger through the hole or grasp the finger grip to insert or remove the retainer. The retainer may then be re-used or stored for future use. Additionally, the optional finger hole or finger grip may be used to hang a label, tag, or ribbon for target identification, or any other item of interest.

The head of the device is also optionally configured in a shape to deflect a projectile. When in use, the retainer is inserted into the substrate with the head of the device facing the user. If a user fires a projectile (arrow, bullet, pellet, or the like) and misses the target, the projectile may hit the head of the retainer. The shape of the head of the retainer is designed to reduce damage to both the target retainer and the projectile in the event that the projectile hits the retainer. The shape of the head may be configured in such a way that the end of the head reduces the effect of the impact by diverting the force away from the device. This may be accomplished with an arcuate, rounded, or triangular shaped end of the head.

The tip of the present invention forms a sharp end which may be inserted into substrates of various densities. The tip is designed to be of sufficient strength to pierce the target substrate and target covering (if a covering is in use). The tip may be a continuous feature of the retainer device or the tip may be configured to be removable, replaced, or otherwise attachable to the retainer.

The shaft of the present invention connects the tip of the device to the head of the device. The shaft is an impact-hold-resistant shaft. The shaft includes an impact-hold-resistance feature, which functions to hold the retainer in place once the device is inserted into the target substrate or substrate covering. It is a function of the shaft to retain and hold the target retainer in place within the target substrate. The impact-hold resistance feature may be serrated edges of the shaft, but not limited thereto, that are designed to secure the device in place with target substrates of various densities. The shaft is of selectable length to provide sufficient support to secure a target or to the target substrate or target substrate covering. That is, for example, a relatively dense substrate may result in a need for a first shaft length while a relatively loose substrate density may result in a need for a second shaft length, with the second shaft length longer than the first shaft length. The thickness of the shaft may also be variable to best fit the density of the substrate.

In an embodiment of the present invention, the retainer device is a single, continuous material such as a plastic or a metal in a unitary form. The head of the device has an optional eyelet wherein the user may utilize the eyelet to insert or remove the retainer from the target substrate. The tip of the retainer device pierces the target substrate when the user inserts the retainer device. The shaft and impact-hold-resistance feature of the shaft secures and retains the present invention in place once the device is inserted and increase impact hold resistance during impact from projectiles. Once inserted, the present invention has only the head of the device showing. The head of the device contains a triangular face such that a projectile that hits the head of the device will be deflected to the side of the device, thus preventing damage to the projectile and the retainer device. The triangular face may have an end with a pointed shape or an arcuate shape designed to deflect an amount of force away from the retainer to prevent or limit damage to the retainer.

In another embodiment of the present invention, the retainer device includes distinct head, shaft, and tip elements that are joined together, with the serrated edges of the shaft optionally also being separate pieces connected together to form the desired embodiment. Any one or more of the head, tip, shaft, and impact-hold-resistance feature may be replaced as desired. The head, tip, shaft, and impact-hold-resistance feature may be secured together with screw threads, glue, clips, or other such forms of attachment. Additionally, each of the head, tip, shaft, and impact-hold-resistance feature may be made of a metallic material, a non-metallic material, or a combination thereof. The materials used to make the components of the target retainer are selected to have characteristics suitable to perform the function of target retention for different substrate types. That is, the material must provide adequate stiffness with enough flexibility to avoid shattering if impacted by the projectile.

### BRIEF DESCRIPTION OF THE DRAWINGS

FIG. 1 is a bottom perspective view of the target retainer of the present invention.

FIG. 2 is a side elevation view of the present invention.

FIG. 3 is a front elevation view of the present invention.

FIG. 4 is a bottom view of the present invention.

FIG. 5 is a perspective view of set of target retainers of the present invention in use with a target and target substrate.

### DETAILED DESCRIPTION OF THE INVENTION

The following detailed description is of the best currently contemplated modes of carrying out the exemplary embodiments of the invention. The description is not to be taken in a limiting sense but is made merely for the purpose of illustrating the general principles of the invention, since the scope of the invention is best defined by the appended claims.

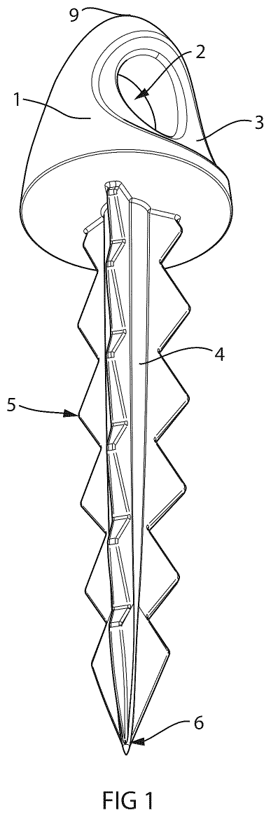

A target retaining device 10 of the present invention is shown in FIGS. 1-4. The device 10 has a head 1, a shaft 4, and a tip 6. The head 1 has an optional eyelet 2, an optional finger grip 3, and an end 9. The shaft 4 has a plurality of impact-hold-resistance features such as optional serrated blades 5. FIG. 5 depicts a plurality of the target retaining devices 10 of the present invention in use with a target 7 and target substrate 8. As shown in FIG. 5, a plurality of the devices may be used to secure the target 7 to the target substrate 8. Alternatively, a single one of the devices 10 may be used to retain the target 7 to the substrate 8.

The optional eyelet 2 of the head 1 provides a method by which the user may insert a finger or other device to insert or remove the device 10 into or from the target 7 and the target substrate 8. The optional finger grip 3 of the head 1 is arranged to provide an added gripping surface to facilitate insertion or removal of the device 10. The eyelet 2 and finger grip 3 are designed to provide an ergonomic method and improve the ease with which the device 10 may be inserted or removed. Additionally, the optional eyelet 2 of the head 1 provides a method in which the user may attach an object or plurality of objects to the device 10.

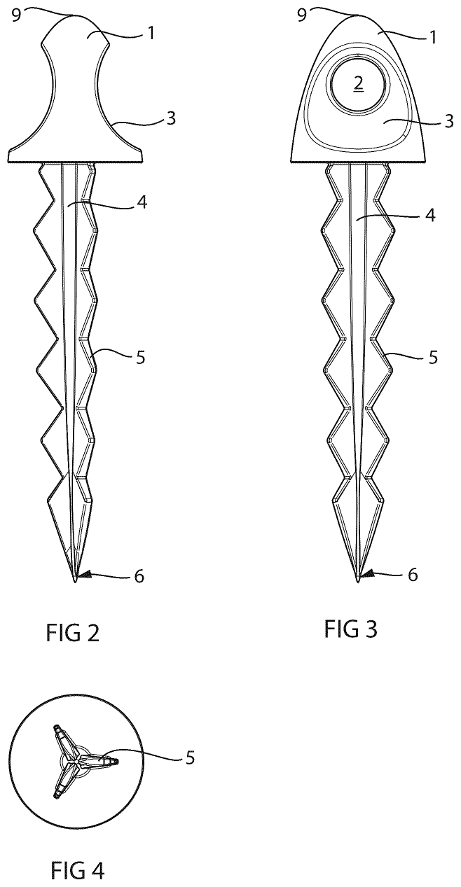

The head 1 of the device 10 may be shaped in a parabolic, arcuate, triangular, or other shape designed to deflect a projectile if the device 10 is struck. When the device 10 is inserted into the substrate 8, the end 9 of the head 1 is closest to and facing the user, with the head 1 protruding from the substrate 8 and the shaft 4 and tip 6 removably engaged with the substrate 8. FIG. 2 depicts the head 1 of the device 10 in an arcuate configuration. If the head 1 of the device 10 is struck by a projectile from the user's direction, the head 1 shape is designed to be angled or curved rather than flat to ensure that the projectile is deflected away from the device 10 and into the surrounding target 7 or target substrate 8 rather than rebounding to the user. The deflection of the projectile serves to minimize damage the projectile, the user, and the device 10.

The tip 6 of the device 10 may be fabricated of a plastic material, metal, other hard substance, or any combination thereof suitable for piercing substrates of various densities. The tip 6 pierces the target 7 and the target substrate 8, allowing the device 10 to be inserted into the target substrate 8 to secure the target 7 and hold the target 7 in place during impact of projectile(s). The tip 6 may be, fixed, removable or replaceable. FIG. 2 depicts the device 10 with a tip 6 that may be reinforced or removable. The device 10 may be formed by combining distinct pieces of the head 1, shaft 4, tip 6, and impact-hold resistance feature in the form of serrated blades 5. Alternatively, the device 10 may be formed with one or more of the head 1, shaft 4, tip 6, and serrated blades 5 as a singular, continuous material. FIG. 3 depicts the device 10 with the tip 6 formed of a singular, continuous material with the shaft 4 and the serrated blades 5.

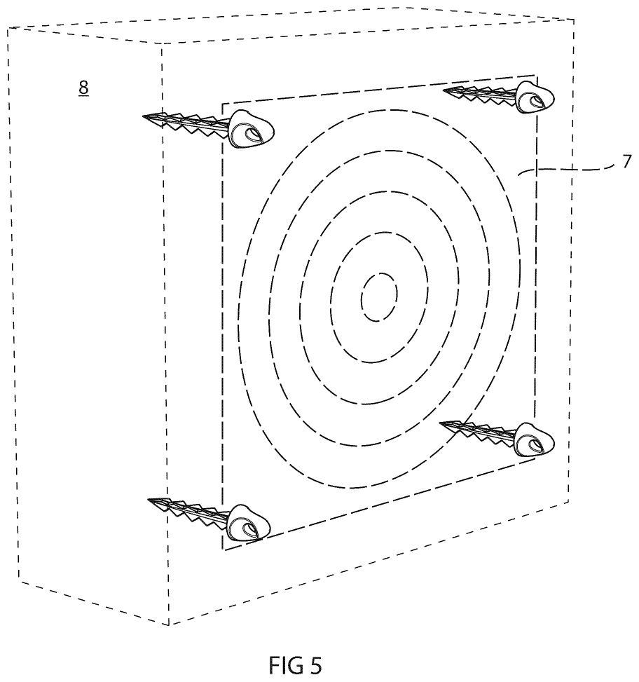

The shaft 4 of the device 10 couples the head 1 and the tip 6. The shaft 4 is designed to provide the length necessary for the device 10 to be inserted to the target substrate 8 to sufficiently secure the target 7. The shaft 4 may be equipped with a multitude of serrated blades 5. The serrated blades 5 provide support when the device 10 is inserted into the target 7 and target substrate 8 to anchor the device 10 to the target substrate 8, substrate covering, or substrate exterior. The serrated blades 5 may be located along the entire length of the shaft 4 or may be located on a portion of the shaft 4. FIG. 4 depicts the device 10 with three serrated blades 5. The device 10 may be formed with more or fewer blades 5. The shaft 4 may secure the head 1 and tip 6 together while the blades 5 are attached about the shaft 4, either permanently, removably, or as a unitary construct.

FIG. 5 depicts the present invention 10 in use with a target 7 and target substrate 8. As depicted, the device 10 is inserted through the target 7 and into the target substrate 8. The tip 6 of the device 10 pierces the target 7 when the device 10 is inserted into the target substrate 8, substrate covering, or exterior to allow the shaft 4 to be anchored via the blades 5 into the target substrate 8. The impact-hold-resistance feature as the example serrated blades 5 provide anchoring of the device 10 to the substrate 8. The head 1 of the device 10 is configured to remain accessible for the user to remove the device 10 and target 7 from the substrate 8 as desired. The head 1 is configured with a shape designed to deflect a projectile if the device 10 is struck when in use to minimize damage to the projectile and the device 10.

In another embodiment, the device 10 may be formed with a head 1, a shaft 4, and a tip 6. The head 1 is formed with an ergonomic finger grip 3. The head 1 may be shaped in an angular or arcuate configuration. The head 1 may also have an optional eyelet 2. The optional eyelet 2 may also be used to secure a label, tag, or ribbon. In another embodiment, the device 10 may be used to hang a target 7 using the optional eyelet 2 and a method of fastening the target 7 to the eyelet 2, such as a string, wire, or other method of adherence.

The present invention has been described with reference to specific examples and configurations. It is only intended to be limited to the description set out in the claims and equivalents.

What is claimed is:

1. A target retainer configured to retain a target to a target substrate, the target retainer comprising:
a head;
a shaft; and
a tip, wherein the shaft couples the head to the tip; and
wherein the shaft has an impact-hold-resistance feature arranged to removably secure the target retainer in the target substrate.

2. The device of claim 1 wherein the head has a finger grip.

3. The device of claim 1 wherein the head is formed in a parabolic shape.

4. The device of claim 1 wherein the head is formed in a triangular shape.

5. The device of claim 1 wherein the head has an eyelet.

6. The device of claim 1 wherein the serrated blades extend the length of the shaft.

7. The device of claim 1 wherein the impact-hold-resistance feature is two or more serrated blades extending a portion of the length of the shaft.

8. The device of claim 1 wherein the tip is removable.

9. The device of claim 1 wherein the head is removable.

10. The device of claim 1 wherein the head, shaft, tip, and impact-hold-resistance feature are made as one continuous structure.

11. The device of claim 1 wherein one or more of the head, shaft, tip, and impact-hold-resistance feature is/are made of a non-metallic material.

12. The device of claim 1 wherein one or more of the head, shaft, tip, and impact-hold-resistance feature is/are made of a metallic material.

13. A target retainer configured to retain a target to a target substrate, the target retainer comprising:
a head, wherein the head has a finger grip;
a shaft; and
a tip, wherein the shaft couples the head to the tip.

14. The device of claim 13 wherein the head is formed in a parabolic shape.

15. The device of claim 13 wherein the head is formed in a triangular shape.

16. The device of claim 13 wherein the head has an eyelet.

17. The device of claim 13 wherein the tip is removable.

18. The device of claim 13 wherein the head is removable.

19. The device of claim 13 wherein the head, shaft, and tip are made as one continuous structure.

20. The device of claim 13 wherein one or more of the head, shaft, and tip is/are made of a non-metallic material.
